(19) United States
(12) Patent Application Publication
(10) Pub. No.: US 2005/0001823 A1
(43) Pub. Date: Jan. 6, 2005

(54) Real motion detection sampling and recording for writing instruments and small tracking instruments using electrically active material with viscosity

(76) Inventor: David Bogart Dort, Washington, DC (US)

Correspondence Address: DORT INTELLECTUAL PROPERTY LEGAL GROUP P.C, BOX 66148, WASHINGTON, DC, 20035, US

(21) Appl. No.: 10/816,531

(22) Filed: Apr. 1, 2004

Related U.S. Application Data
(60) Provisional application No. 60/475,756, filed on Jun. 4, 2003.

(51) Int. Cl. G09G 5/00

(52) U.S. Cl. 345/179

(57) ABSTRACT

The present invention details a system for tracking writing motions internally to the pen (or other instrument) and communicating such motions to a general or specific purposes computer systems. In a preferred embodiment the present invention uses multiple tubes with electrically active material with viscosity surfaces in order to generate the necessary signals to determine the motion of the device in a targeted number of degrees. The data is then filtered and optionally processed and stored. The data then can be downloaded to a computer or other processing device to determine the motion of the pen or other tracking device.

### REFERENCE TO PRIORITY DOCUMENTS

This Application claims priority under 35 U.S.C. §119(e) and incorporates by reference, U.S. Provisional Application Ser. No. 60/475,756 entitled REAL MOTION DETECTION SAMPLING, RECORDING AND RECALL FOR PENS AND TRACKING INSTRUMENTS filed Jun. 4, 2003 in the in the United States Patent and Trademark Office, herein for all purposes.

### BACKGROUND

The digital pen by LogicTech is an example of a writing instrument that can record the movement of the pen in order to recall it electronically so that what is written by the pen can be easily digitized. The prior art digital pen includes an optical sensor or camera, which tracks the movement based on special “grided” paper. The pen is bulky and works with the special paper for recording purposes.

Other inventions for tracking motion have been numerous, such as which measure motion based on accelerometers or gyroscopes. These include patents assigned to Vega Vista, Inc. of Mountain View, Calif. which are hereby incorporated by reference and others. The use of accelerometers for motion in 3 dimensions is computationally difficult, especially on a minute scale.

What is needed however, is a compact tracking and recall system which is portable and light and does not require special paper. Furthemore, the computational problems associated with standard movement devices accelerometers and gyroscopes makes internal calculation of movement more difficult, so the need for a simpler recording mechanism is apparent.

### SUMMARY

The present invention details a system for tracking writing motions internally to the pen (or other instrument) and communicating such motions to a general or specific purposes computer systems. In a preferred embodiment the present invention uses multiple tubes with electrically active material with viscosity surfaces in order to generate the necessary signals to determine the motion of the device in a targeted number of degrees. The data is then filtered and optionally processed and stored. The data then can be downloaded to a computer or other processing device to determine the motion of the pen or other tracking device.

### BRIEF DESCRIPTION OF THE DRAWINGS

The present invention can be better understood by reference to the illustrations in which:

FIG. 1 is a hollow conducting rectangular tube as may be implemented in the present invention;

FIG. 2 shows the hollow conducting tube with 4 or more conductive regions, separated by insulators which house resistors;

FIG. 3 illustrates the operation of the present invention due to the change in the resistance of individual measuring region, due to the change in the conducting fluid level;

FIG. 4 illustrates an alternate embodiment where the regions are divided down the center of each rectangular region;

FIG. 5 shows the connectors to the source and the recording sink;

FIG. 6A illustrates a cylindrical emdodiment of the motion detection tube with 5 conductive regions;

FIG. 6B shows a single cylindrical detection tube for the cylindrical conductive regions;

FIG. 7 is illustrative of the angles to be recorded in the present invention (for a six degree embodiment of the invention) in a recording pen;

FIG. 8 shows the time recording of individual motion as implemented in the present invention (for 4 time slots) for a single degree of freedom (theta);

FIG. 9A shows the change level of the conducting fluid level in the rectangular body on one user motion which can detect or measure an axis of motion or rotational motion in the device to be tracked;

FIG. 9B shows the differential change level in one dimension on two resistive regions;

FIG. 10 shows the change level of the conducting fluid level in the cylindrial body on one user motion which can detect or measure 3 angles of the device to be tracked;

FIG. 11 depicts the measuring tube with 2 virtual resistors attached to a filter and/or computational device;

FIG. 12 shows a filtering system for the sink with multiple logical signal generation;

FIGS. 13A-C show a sample of a moving detection tube and the effect on the electrically active viscous material;

FIG. 14 shows the rectangular detection system tube with a single power source contact;

FIG. 15 shows a sample embodiment of an optional internal processing system for detection signal processing;

FIG. 16 illustrates a storage and output schematic for a particular embodiment of the motion recording system;

FIG. 17 shows the cylindrical detection system tube with a single power source contact;

FIG. 18 shows the measuring cylinder with a source and a sink recording and computational model as implemented in a pen or other recording instrument;

### DETAILED DESCRIPTION OF THE DRAWINGS

Throuought the detailed description the term “fluid with electrical properties” or “electrically conducting fluid” is used. This term is meant to capture the spirit of the invention in that a viscous material is contacting a conductor in planar or conical wedge form on one or more faces. The resistance of the concuctor will vary depending on the electrical properties of the viscous material. The viscous material may have other desired physical properties, such as changing viscosity based on electrical current, but such features are not critical to the present invention.

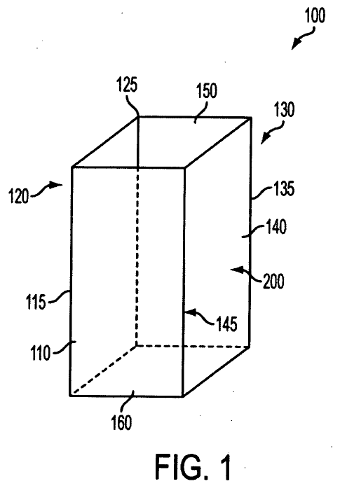

FIG. 1 is an illustration of the rectangular electrical motion detection tube 100 of an embodiment present invention. The tube 100 includes 4 conductive regions 110, 120, 130 and 140, with divider regions 115 (110-120), 125 (120-130), 135 (130-140) and 145 (140-110), surrounding a hollow space 200 which is preferrably vacuum sealed at a desired vacuum pressure P(v). Top and bottom zone 150 and 160 also enclose hollow space 200. As will be discussed below, the rectangular tube 100 may be divided in several ways to inmprove the sampling of the motion detection. The conductive region may also be though of as a “resistive region” as well. The material making up the conductive region will best be a metal with some degree of resistivity and will be responsive to the electrically active fluid such that the conductivity or resistivity will change based on the amount of contact with the electrically active fluid.

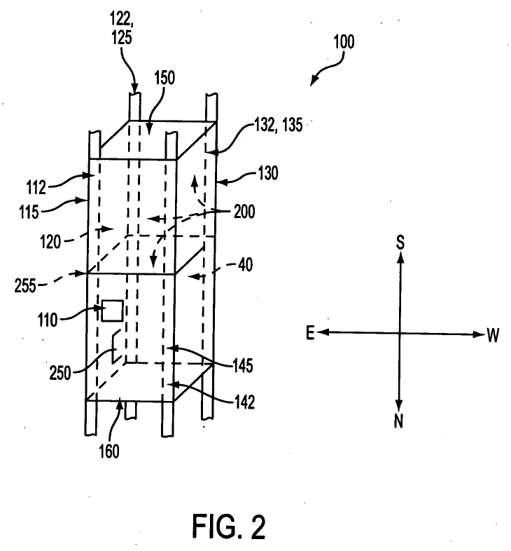

FIG. 2 shows a first embodiment of the the motion detection tube 100′ with conducting regions. Along divider regions 115, 125, 135, 145 is a resistive strip 112, 122, 132, and 142 surrounded by an insulator (not shown). Hollow space 200 is filled with a fluid with desired electrical properties 250 to fluid level 255 before being vacuum sealed to a desired pressure P(v).

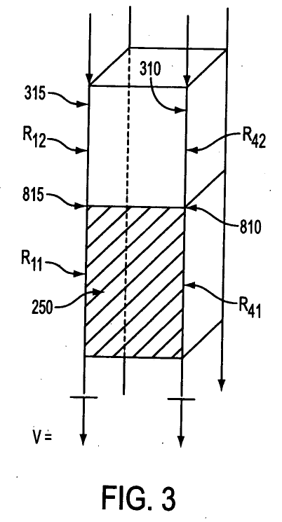

FIG. 3 shows a sample of the detection system of the present invention. Each resistor 112, . . . 142 on a conductive region 110 . . . 140 has two resistive zone properties. The edge of the first zone, R11, R21, R31 (not shown), and R41, shown as 815, 825, 835, and 845 respectively, is the level of the resistor below the electrical manipulating fluid level 255. The second zone R12, R22, R32 and R42, shown as 315, 325, 335, and 345 respectively is above the fluid level 255. The regions of the conductive zones 110 . . . 410 below the level 255 are marked as 810 . . . 840 and the regions above as 310 . . . 340, each with conductive property C11, C41 . . . and C12 . . . C42 (not labeled), respectively.

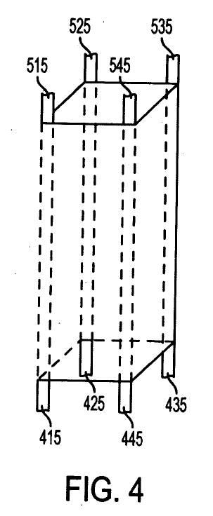

Referring now to FIG. 4, in a particular embodiment of the detection tube, electrical sources 515, 525, 535, 545, respectively, contacting resistive strips 112, 122 (not shown), 132, and 142, respectively are shown. Electrical sinks 415, 425, 435 and 445 also contact the strips 112 . . . 142 respectively. Although, the power source and sink connected to the resistive strip is one embodiment of the detection tube, in other embodiments the conductive region may be used or both the conductive and resistive regions can be used.

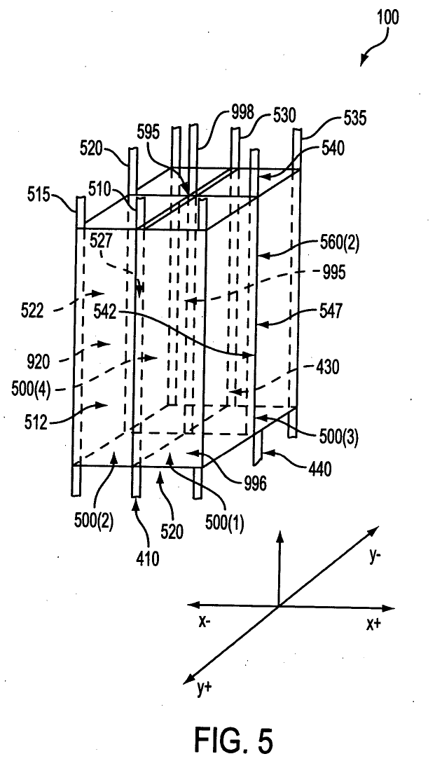

FIG. 5 shows an optional internal regional insulating or conducting divider 595 dividing the hollow space 200 into 4 individual rectangular cylindrical spaces 500(1) . . . 500(4). Also included are center resistive power soures 510, 520, 530 and 540, and sinks 410, 420, 430, 440, each of which is connect to a center resistive strip each of which has positive regions 512, 522, 532 and 542 and negative regions 517, 527, 537, 547, respectively. Also shown is an optional central power source 998 and sink 996 connected to a center resistor 995 with up to 8 regions 995(512), 995(517), 995 (522), 995 (527) . . . 995(547), which may correspond to the counter part positive or negative center center resistive strip 512, . . . 547 as may be appropriate.

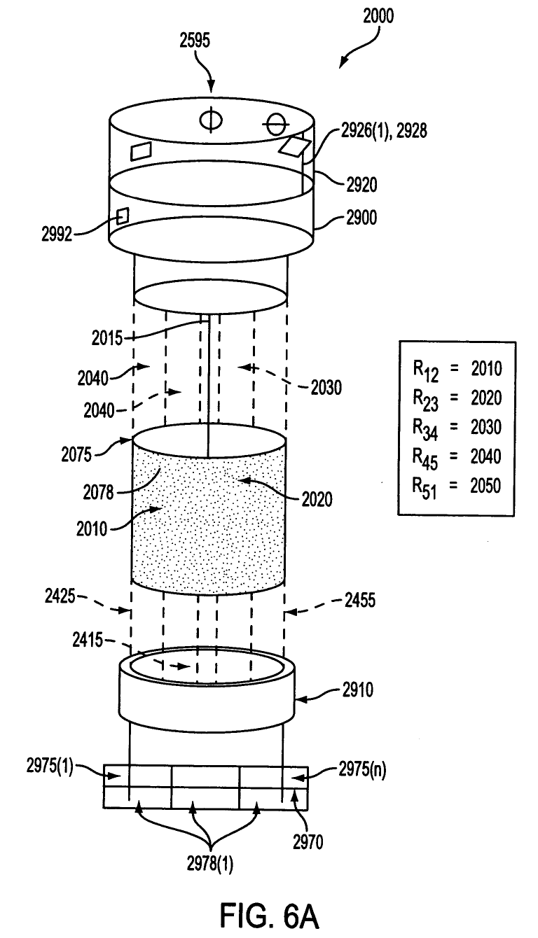

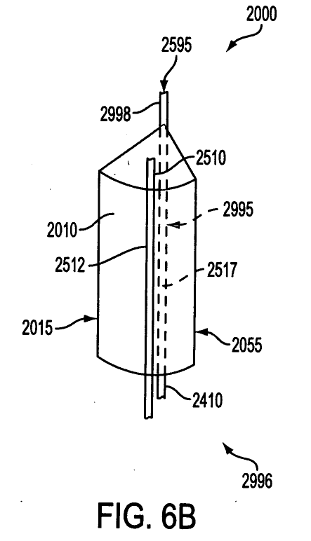

As can be appreciated by those skilled in the art, alternate shapes of the detection tube may used as correspond to the natural motion detection needs of the final use of the device. FIG. 6A illustrates an alternate cylindrical embodiment of the invention 2000 with 5 semi-circular regions 2010, 2020 . . . 2050 and divider regions 2015 . . . 2055, resistive strips 2012 . . . 2052 much in a non-rectangular arrangement similar to the rectangular tube 100. The regions 2010 . . . 2050 surround hollow space 2200 with a elctrically manipulating fluid 2250 filled to level 2255. Power source(s) 2300 are connected to regions 2010 . . . 2050 and strips 2012 . . . 2052 by source connections 2515 . . . 2515 much in the same manner as the rectangular tube 100. Sink connections 2410 . . . 2450 are also connected to the strips 2012 . . . 2052. Although 5 regions are used in the present invention, other numbers of regions may be used as needed by the final intended use.

Also shown, are the pulse generator and initialization computation device 2200 which generally controls the power source(s) 2900. The pulse generator 2920 has a least one clock 2926(1) . . . 2926(n) and may have a separate clock generator for each connection 2515 . . . 2555, to the resisitve strips 2015 . . . 2055 or other connection 2510 . . . 2550 that run through the detection cylinder 2000. Power souce 2900, may be connected to an external battery 2990 through a connection 2992 directly or throught the pulse generator 2920.

A collecting sink 2910 also collects the electrical currents passing through the appropriate connections (i.e. 2410, 2015, etc.). A collecting sink 2910 is detailed later but also may have a separate clock 2912 and a voltage filtration system 3000, which may filter out voltages that do not meet an activation or retardation threshold, depending on the requirements of the final use of the device. A digital recorder 2970 includes at least one storage module 2975 include RAM or EEPROM, but preferrably solid state storage. Also included is an optional external connection 2978, which in a preferred embodiment is a transponder which can be read wirelessly, but in an alternate embodiment is a mini USB port or firewire port which is connected at the top of the pen or other convenient location.

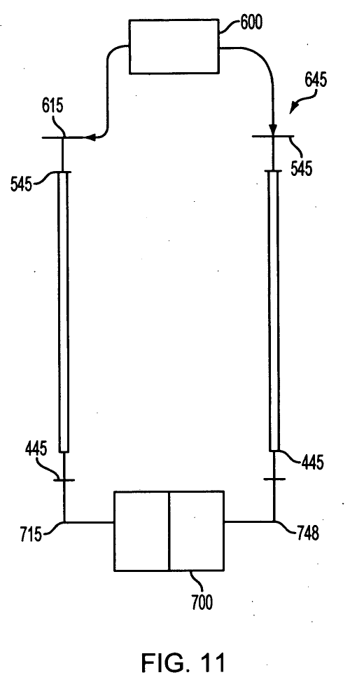

The rectangular counterpart to the cylindrical invention 100 is shown in FIG. 11. Also shown is an optional one or more gyroscopes 1250 in computational device 1200. A mini USB device or firewire port 1275 may be connected to the upper region of the detection system to facilitate efficient data transfer and ergonomics.

FIG. 6B shows an optional center barrier 2595 acts in a similar manner to the rectangular space divider 595 to divide the hollow space 2200 into 5 spaces 2500(1) . . . 2500(5). A single cylindrical portion 2010 is shown for purposes of simplification. There are similar connections 2510 as to those in the rectangular embodiment. A center power source 2998 and sink 2996 are also connected to a center resistive strip 2995 with 10 zones (2995 (2522), 2995 (2527) . . . ) similar to the rectangular embodiment. As can be appreciated by those skilled in the art, the number of zones can be varied as needed from the final use of the pen or tracking instrument. For example, the cylindrical tube may have six regions (each covering 60 degrees of arc) instead of the 5 depicted in FIG. 6A. The more regions the more “degrees of freedom” that can be measured. However, too many regions may be counterproductive and create too complex a set of signals to benefire from the manufacturing economy provided by the invention.

Referring now to FIG. 17, it is also contemplated that the electrical source may be a single band 2100 connected to the top of the cylinder 2000. This reduces the amount of electrical components needed and is still efficient as the voltage differences at the sinks are the measurements that need to be recorded for the preent invention. The rectangular version of this is shown in FIG. 14 with single source band 99 connected to all the resistive and conductive regions.

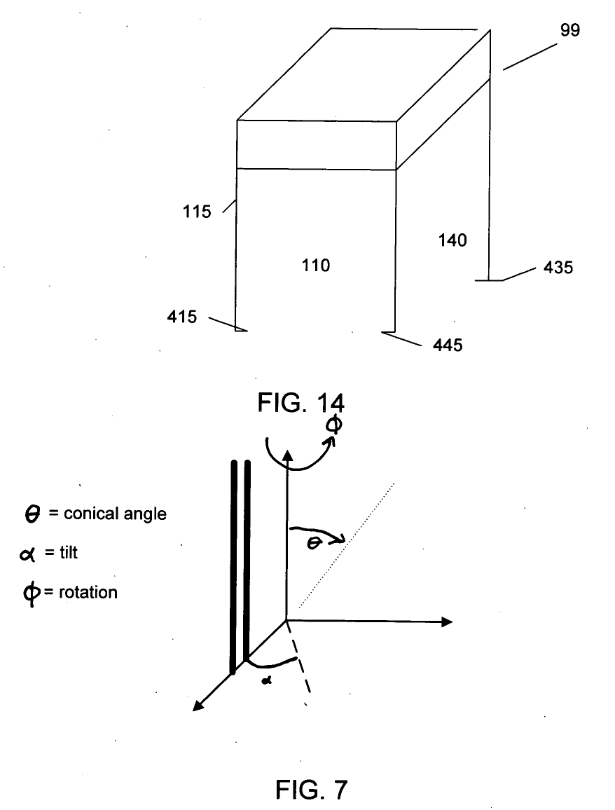

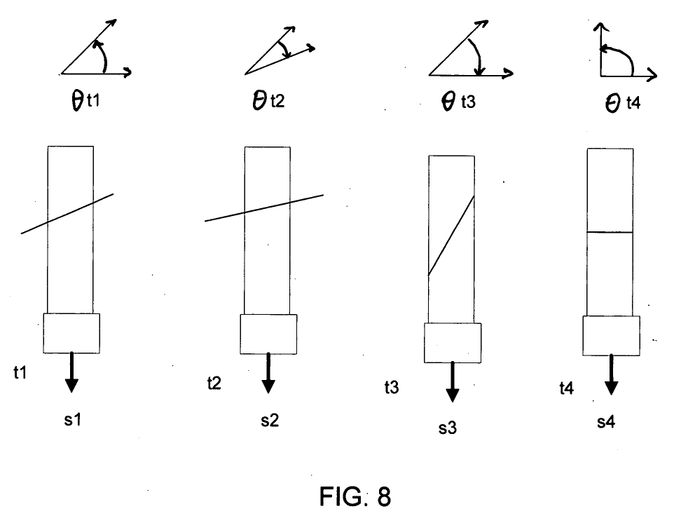

FIG. 7 represents sample descriptions of the (three) angles or degrees of freedom to be calculated for each time t(x) to determine the angle a which the user is holding and moving the pen 2. These are degrees of freedom 4-6 and greatly assist in reducing problems with calculation of movement based on the voltage variances without adding much complex circuitry. However, FIG. 8 is a simple representation of the processing of one angle in FIG. 7 (theta) which is tracked at all point (t(x)) so as to be able to calculate motion effectively. It should be noted that movement in the z (up and down) is expected to be minimal (as well as in the phi rotation) and, as such, only 4 measurements really needed to determine the recorded motion of the pen 2.

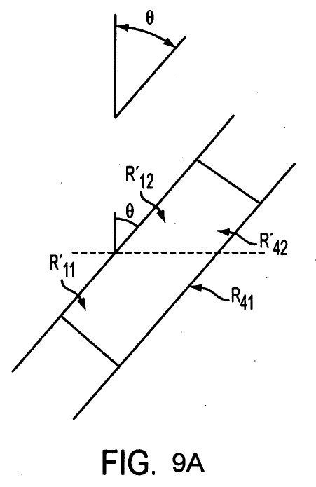

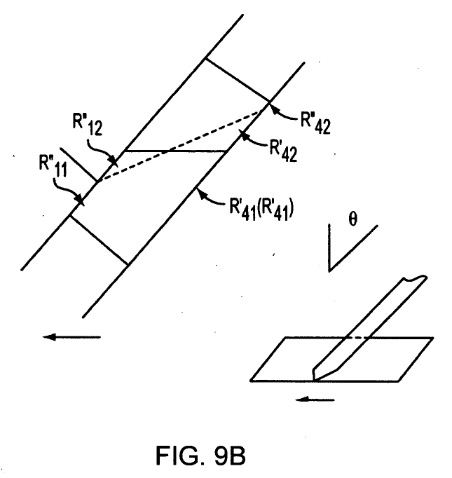

FIG. 9A is an illustration of the differences created in the two regions R′(11) R′(12) etc based the movement of the pen or recording instrument in one axial or angular direction (x in this case). Thus the viscosity acts like a accelerometer in one instance (axial) and a gyroscope or tilt measurement in other instances (cylindrical or spherical) The angle theta is representative movement of the pen creating a temporary change in the angle of the fluid 250 and creating a voltage variance in the R′11+R′12 resistor from the R′42+R41 resistor. This configuration takes place at time t(init). FIG. 9B represents movement of the cylinder 100 or 2000 in one direction in FIG. 9A at a time (t(init)+1 unit). This creates another voltage differential to be processed by unit 2900.

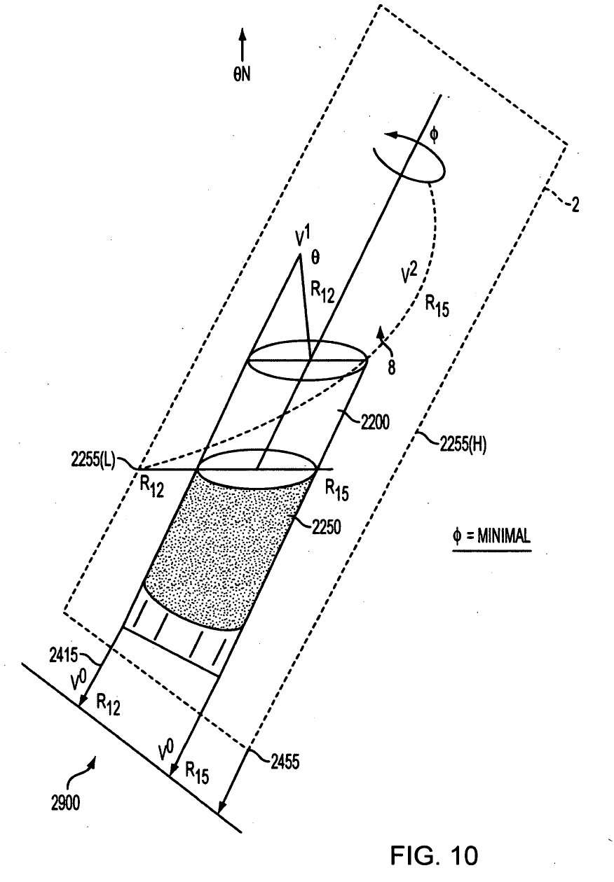

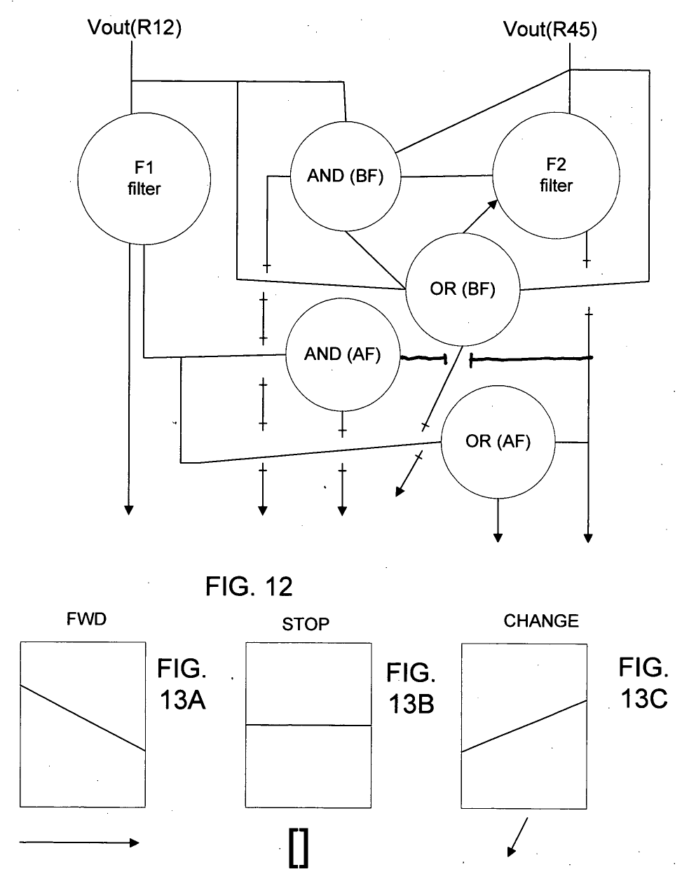

FIG. 10 shows the basic electrical operation of the cylinder motion detection and recording component 2000 for one degree of freedom. When a pen or tracking device 2 is tilted at angle theta (A(l)) from the normal (theta (N)), the fluid 2250 in chamber 2200 moves with the pen 2, creating at least two electrically active fluid levels in two respective regions (in this case R12 and R45 is shown) 2255(L) and 2255(H) respectively, but may be any combination of regions depending on the end use of the device and the accuracy needed. In measuring the rotation of the device Phi tends to less imporant for a pen 2, but may be important in other devices. The differences of the outputs V(out)R12 and V(out)R45 depends on the properties of the electrically manipulating fluid 2250, but the voltage will now be distingsuishable. The sink 2900 collects the two voltages through connections 2415 and 2455, respectively and can process them in the voltage screening system 3000 to record the data for theta (A(l)) at time (t) based on the two volatges. Alternately, if so desired a transisitor may be placed between the two outputs requiring a threshold of either V(out)R12 or V(out)R45 when compared. This is shown in FIG. 12 with multiple output configurations.

FIG. 11 represents a sample functional schematic of embodiments in which connections 615 and 645 carry a pulse from one or more clocks 600 (in unit 2200) to the voltage differential processing unit 700 in the form of the detection tubes (described in FIGS. 1-6C) which may have one or more voltage threshold filters 715 . . . 745).

FIG. 12 also shows how a filtering unit may be implemented in one or more embodiments in a logic sequence. Two filters F1 and F2 operate on the output V(o)R12 and V(o)R45 from two sides of a detection tube (not shown). The output may be combined before filtering in an AND gate, it may be combine before filtering in an OR gate or the signals may be combined after filtering. Of course, FIG. 12 simply demonstrates a very simple model, but other operators, such as comparitors, XORs, NOTs, NANDs, multiple threshold filters may be used in any combination that is appropriate for the proper signal generation as can be appreciated by those skilled in the art. In a alternate embodiment the logic for determining the proper signal may be a PFGA or other device that may be adjusted or trained.

FIGS. 13A-C show a simplified version of the sample detection tube moving in a particular direction, stopping, and changing direction. The electrically active fluid will continue to move forward as the pen stops and changes direction 13B and C. Thus, the filter will be able to determine that the pen has changed direction from the resulting voltage changes from 13B to 13C. Most likely this change will be slightly delayed due to the physical nature of the viscosity of the electrically active fluid.

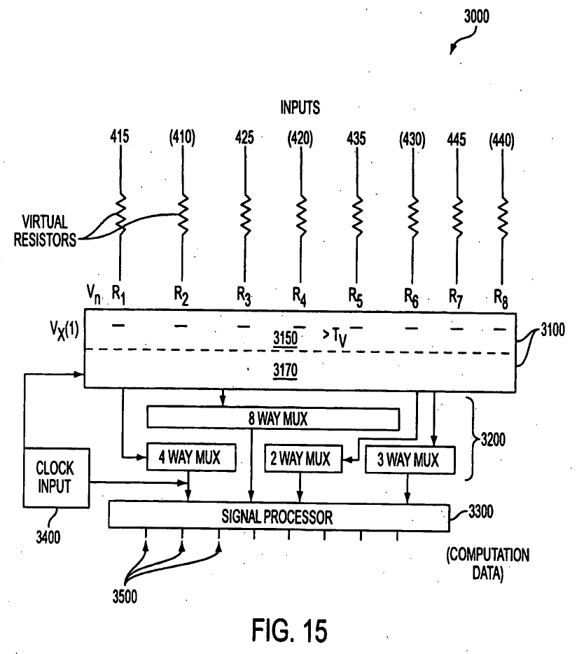

FIG. 15 is a sample of the voltage differential processor 3000 which may be in the form of an ASIC or embedded software. A sample of 8 inputs are processed by filter 3100 which may include a threshold zone 3150 eliminated all voltages less than a determined threshold for non-meaningful movement of the pen 2, eliminating needless processing. Module 3170 can time stamp all inputs with a pulse from the clock 3400 that may be based on the clock in unit 2200. It may also be effective by giving only digital output based on the 8 inputs. Thus, the optional multiplexer complex 3200 may located inside the module 3170 or external if the module is only an analog processor or other type of filter/signal processor (i.e. normalization, etc.). The output for at least 4 degrees of freedom is put inside an optional signal processor 3300 which can optionally calculate each value for the degree of freedom and send it to storage via output 3500 based on the time stamp in 3170 or in the signal processor 3300.

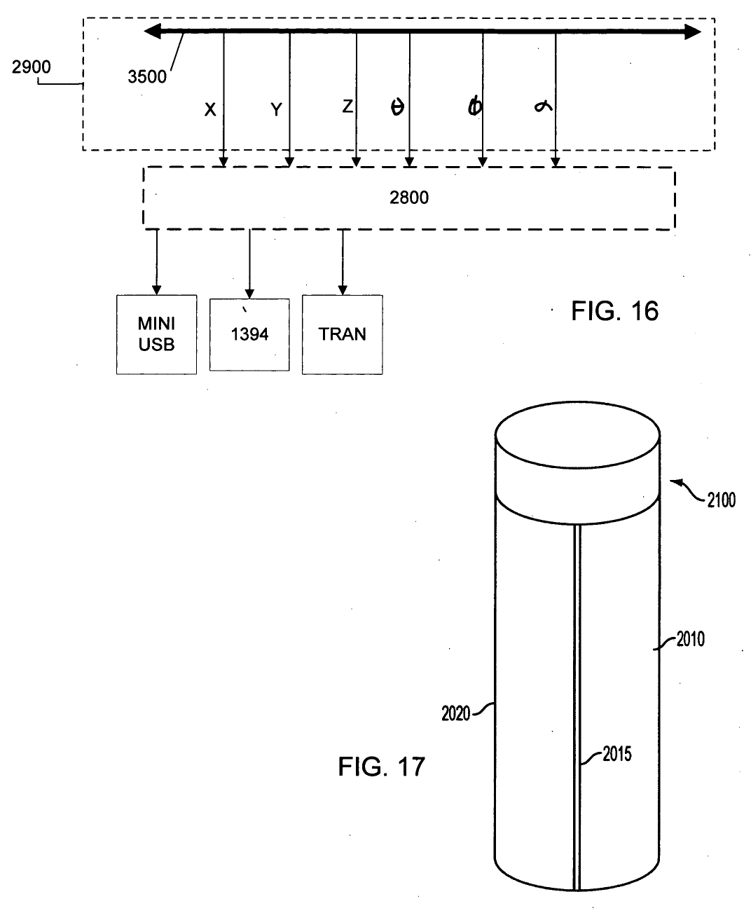

FIG. 16 illustrates storage of a single recorded degree of freedom in the storage 2800 through an optional interface or translator 2850. The storage 2800 can store each degree (shown as x, y, z, theta, phi and alpha or gamma) data separately or together, but for common storage, the degree the data is relating to need to be marked in the module 3170 or the signal processor 3300. The data is ported upon request (not shown) or schedule to a port for processing in a computer (mainly a PC) running a recording and calculation program shown as a mini USB or a 1394 firewire connection. A transponder TRAN is optionally another way to transport data to a computer capable of processing the data for each degree. Such that the pen may be placed against another device to download the data on the motion of the pen or other tracking device.

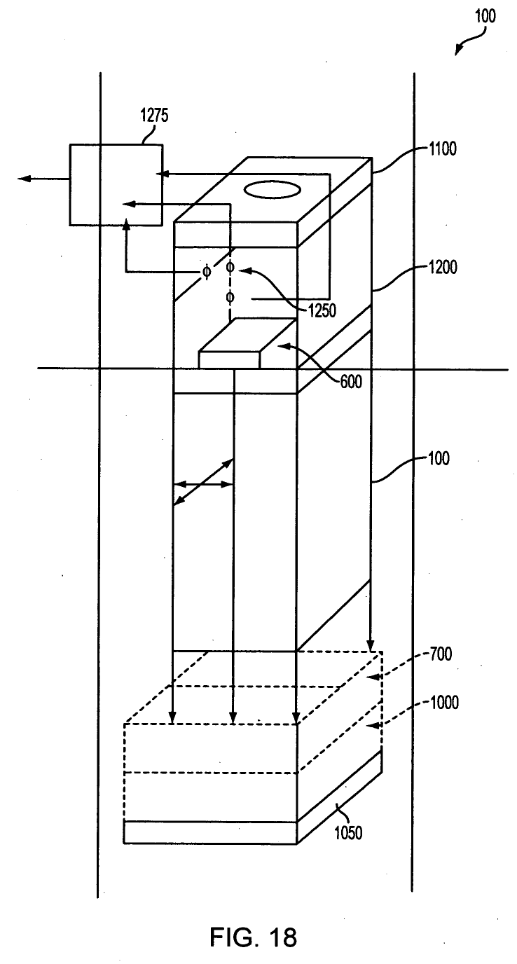

The rectangular counterpart to the cylindrical invention 100 is shown in FIG. 18 in the pen 2. Also shown is an optional one or more gyroscopes or thin film magnetic field detectors 1250 (for measuring theta, phi and alpha or gamma) in computational device 1200. A mini USB device or firewire port 1275 may be connected to the upper region of the detection system to facilitate efficient data transfer and ergonomics.

There are many other relevant features including initialization by motion and the entire motion determination processing module which are optional and need not be taught to practice the invention.

1. A system for digitally recording the motion of an instrument including:
a power source;
at least two hollow tubes made of electricially conductive material coupled to said power source through first connection, said at least two hollow tubes including a viscous material in the interior contacting said electrically conductive material, wherein when said at least one of said at least hollow tubes moves in an axial or rotational direction, said viscous material contacting said electrical conductive material;
a power sink coupled with said at least two electrically conductive hollow tubes through a second connection.

2. The system as recited in claim 1, further including a transistor coupled in between said at least two hollow tubes and said second connection.

3. The system as recited in claim 2, wherein said transistor does not provide an electrical signal to said power sink unless the power reaches a voltage indicative of at least a detecton threshold.

4. The system as recited in claim 2, wherein said transistor does not provide an electrical signal to said power sink unless the power reaches a power indicative of at least a detecton threshold.

5. The system as recited in claim 1, wherein said power source is pulsed.

6. The system as recited in claim 5, wherein said pulsed power source is pulsed at less than 1 millisecond.

7. The system as recited in claim 1, wherein there are four of said hollow tubes.

8. The system as recited in claim 1, wherein there is a hollow tube for each axial directions, and at least two rotational directions.

9. The system as recited in claim 8, wherein said at least two rotational directions incidude tilt from a vertical upright position (theta) and clock position (alpha).

10. The system as recited in claim 1, wherein said sink is coupled with electronic storage.

11. The system as recited in claim 10, wherein said electronic storage stores data

12. The system as recited in claim 1, wherein said hollow tubes are

13. The system as recited in claim 1, wherein said hollow tubes are substantially cylindrical.

14. A system for tracking the motion of a writing instrument including:
a clock controlling a power source;
a series of virtual resistors coupled with said power source, each virtual resistor including a detection tube with a electrically active varying material, wherein the resistance of said of each virtual resistor is dependent upon the configuration of said electrically actice varying material, said material varying with motion of said writing instrument;
a power sink; and
a signal processor.

15. The system as recited in claim 14 further including a filter for at least one of said resistors.

16. The system as recited in claim 15, whereing there are at least 4 said virtual resistors corresponding to at least two axial directions and at least two rotational directions.
